(19) United States
(12) Patent Application Publication
(10) Pub. No.: US 2021/0360928 A1
(43) Pub. Date: Nov. 25, 2021

(54) ANTIMICROBIAL/ANTIVIRAL NONWOVEN AND APPLICATIONS OF THE SAME

(71) Applicant: Piana Nonwovens, LLC., Cartersville, GA (US)

(72) Inventors: Andrea Piana, Cartersville, GA (US); Michael Stephen DeFranks, Cartersville, GA (US); Eric McCann, Cartersville, GA (US); Andy Hollis, Cartersville, GA (US); Sang-hoon Lim, Cartersville, GA (US); Helias Andriessen, Cartersville, GA (US); Mehran Jafari, Cartersville, GA (US)

(21) Appl. No.: 17/326,948

(22) Filed: May 21, 2021

Related U.S. Application Data
(60) Provisional application No. 63/028,357, filed on May 21, 2020.

(51) Int. Cl. A01N 59/16; A01N 25/34; A01N 25/10; A01N 47/44; A01N 59/20; A01N 33/12; A01N 31/16; A01P 1/00; B01D 39/16; B01D 46/00; D06M 16/00; D06M 11/13; A62B 18/02; A47C 31/10

(52) U.S. Cl. CPC A01N 59/16; A47C 31/11; A01N 25/10; A01N 47/44; A01N 59/20; A01N 33/12; A01N 31/16; A01P 1/00; B01D 39/163; B01D 46/0028; D06M 16/00; D06M 11/13; A62B 18/025; A47C 31/105; B01D 2239/0442; B01D 2239/0618; B01D 2239/10; B01D 2279/65; A01N 25/34

(57) ABSTRACT

Provided are antimicrobial nonwovens comprising antimicrobial chemical treated fibers and untreated binder fibers. 0.0003-0.1 wt. % of one or more silver containing antimicrobial chemicals are used in nonwovens to provide an excellent antimicrobial/antiviral property. Exemplary applications and methods of manufacturing antimicrobial products such as a facial covering, a mattress cover, a surface cover and an air filter are provided.

### CROSS-REFERENCE TO RELATED APPLICATIONS

This application claims priority to U.S. Provisional Application 63/028,357 filed on May 21, 2020. The complete content thereof is herein incorporated by reference.

### FIELD OF THE INVENTION

The invention generally relates to nonwovens with antimicrobial/antiviral properties. In particular, the invention pertains to antimicrobial nonwovens which are formed by blending antimicrobial chemical treated fibers with binder fibers which are not treated with chemicals. The invention further relates to methods of manufacturing and using such antimicrobial nonwovens for shielding and/or preventing viral and/or bacterial infection(s). The antimicrobial nonwovens are particularly useful for manufacturing personal protective equipment, such as facial coverings, air filters, beddings and/or surface covers.

### BACKGROUND

The recent virus outbreak leading to a global pandemic heightened awareness of hygienic environment as well as for importance of personal and public protective articles which are now used daily. Such awareness created a great demand for new products and/or novel approaches that may help to prevent bacterial and/or viral infections. Sanitation and protection by using personal protective equipment (PPE) are commonly used to ensure safety from bacterial and viral infections of broad strains and exposure ranges, some exemplary viruses being SARS-CoV-2 and avian influenza. While total assurance of protection from viruses may not be possible, multiple precautious protocols and use of protective articles have been developed to enable a safer environment, particularly for shared public places.

Such preventive articles may be especially useful to prevent spreading of infections, especially in clinical hospital settings. According to the U.S. Centers for Disease Control and Prevention (CDC) report, approximately 1 out of every 31 U.S. hospitalized patients develop one or more hospital-acquired infections (HAIs) on any given day. The HAIs (i.e., device-associated infections, surgery site infections, etc.) increase direct medical cost in U.S. up to S10 billion annually. Some exemplary types of device-associated infections include central line-associated bloodstream infections, catheter-associated urinary tract infections, and ventilator-associated pneumonia. Hospital-acquired bacterial or viral infections have been causing or contributing to almost 99,000 deaths in each year in the United States alone. Disposable medical articles, such as gowns, drapes, shoe covers, wraps and caps are regularly used to minimize the transmission of such infections, however, commonly used PPE articles do not possess antimicrobial property. In addition, current standard practice in healthcare settings calls for the replacement of PPE after each interaction with a patient; however, recent shortages of PPE have caused many healthcare workers to reuse masks, putting themselves and others at potential risk for infection. Further, disposal of PPE itself may also become a burden to the environment.

At the same time, some bacterial or viral infections are airborne and thus it is critical to control the indoor air quality. Being able to improve the air quality in all environments is paramount to controlling the spread of viruses and particularly important when in confined spaces where air is recycled, such as on an airplane. Most commonly used air controlling appliance is air purifier, which requires good quality air filters for protection. Filters can be found in many different types and forms, which factors all help to address and improve air quality. High-efficiency particulate air (HEPA) filters are very effective and certified to capture 99.97% of particles that are 0.3 micron in diameter; however, their overall efficacy is based upon the ability of devices to move the air towards the filter. Imparting antiviral capacity to more traditional HVAC air handlers is needed.

Currently used nonwoven materials for manufacturing PPE are often coated or layered with an antimicrobial material to kill microbes that contact the surface of the articles. U.S. Pat. No. 6,146,651 describes nonwoven fabrics treated with a biocidal composition including a halogenated phenolic biocide, a water-soluble polymer and at least one surfactant. U.S. Pat. No. 6,503,952 relates to antimicrobial compositions comprising an antimicrobial such as chlorohexidine free base, chlorohexidine salt, polyhexamethylene biguanide, and alexidine, a quaternary ammonium compound and a chlorinated phenol compound. U.S. Pat. Application (2013/0344122) relates to a nonwoven material that is coated with chlorhexidine acetate and triclosan for manufacturing medical articles. Despite their advantages, these commonly used nonwovens or fibers with antimicrobial effect are expensive, thus, from an economic perspective, most of them are not suitable for disposable or even recyclable PPE uses due to their high costs. Further, while the use of antimicrobial coatings on nonwoven materials may be beneficial in reducing the amounts of microbes present on the surface, however, the coating can sometimes compromise the barrier properties of nonwoven materials, thereby increasing the possibility for fluids to penetrate.

Generally, high concentration of antimicrobial compounds is required in these medical articles (e.g., PPE, wound covering, etc.) to reach an appropriate efficacy in antimicrobial functions. For example, U.S. Pat. No. 10,918,103 discloses at least 1 wt. % of antitoxin, in which the percentages of antitoxin chemicals are based on the dry weight of the absorbent wound covering layer. Lesser amounts of antitoxins were suggested not to be used since they rise to insufficient antimicrobial effect.

Thus, there is a need in the art for improved nonwoven materials with effective barrier properties and antimicrobial activities. Further, there is a need for manufacturing and/or application methods of antimicrobial nonwovens and more specifically to manufacture antimicrobial nonwoven PPE, such as facial coverings, beddings, surface covers and air filters, in the most cost effective, accessible, flexible, environmentally friendly (i.e., recyclable and made from recycled materials) manner.

### SUMMARY OF THE INVENTION

The disclosure relates to one or more antimicrobial nonwovens for shielding bacterial or viral infections. The antimicrobial nonwovens are manufactured from synthetic fibers that are partially or entirely treated with one or more antimicrobial chemicals. The nonwovens may be used as produced or in combination with other nonwovens for manufacturing of a plurality of antimicrobial articles (e.g., personal protective equipment, air filter, mattress topper, mattress cover, pillow, seat cover, surface cover, etc.). One of the main advantageous features of the present invention is to require a very small amount (0.0003-0.1 wt. %) of antimicrobial agent in the nonwovens without sacrificing antimicrobial property and product quality, providing just as effective anti-infective, antimicrobial result as compared to using higher amounts of other antimicrobial chemicals.

One aspect of the invention is an antimicrobial nonwoven which comprises 40-90 wt. % of at least one antimicrobial chemical treated fiber and 10-60 wt. % of at least one untreated binder fiber. The total amount of antimicrobial used is suitably about 0.0003-0.1 wt. % of total weight of the nonwoven. In some embodiments, silver chloride is used as an antimicrobial. In other embodiments, chitosan may be used as an antimicrobial agent. In some embodiments, one or more other natural and safe antimicrobial chemicals (e.g., silver nitrate, copper, copper nitrate, zinc, nano-silver, chitosan, triclosan, quaternary ammonium compounds, polybiguanides, etc.) may be used in the nonwoven.

Another aspect of the invention is an antimicrobial nonwoven facial covering, which comprises a nonwoven blend fabric of 40-90 wt. % of at least one treated fiber that are treated with one or more antimicrobial chemicals listed above and 10-60 wt. % of at least one untreated binder fiber. The one or more antimicrobial chemicals used, in some embodiments, are at a concentration of 0.0003-0.1 wt. %. In some embodiments, silver chloride is used as an antimicrobial. In other embodiments, chitosan may be used as an antimicrobial agent. In some embodiments, one or more other natural and safe antimicrobial chemicals (e.g., silver nitrate, copper, copper nitrate, zinc, nano-silver, chitosan, triclosan, quaternary ammonium compounds, polybiguanides, etc.) are used in the nonwoven.

Another aspect of the invention is an antimicrobial nonwoven air filter, which comprises a nonwoven blend fabric of 40-90 wt. % of at least one treated fiber that are treated with one or more antimicrobial chemicals listed above and 10-60 wt. % of at least one untreated binder fiber. The one or more antimicrobial chemicals used, in some embodiments, are at a concentration of 0.0003-0.1 wt. %. In some embodiments, silver chloride is used as an antimicrobial. In other embodiments, chitosan may be used as an antimicrobial agent. In some embodiments, one or more other natural and safe antimicrobial chemicals (e.g., silver nitrate, copper, copper nitrate, zinc, nano-silver, chitosan, triclosan, quaternary ammonium compounds, polybiguanides, etc.) are used in the nonwoven.

In yet another embodiment, the invention is a method of fabricating antimicrobial nonwoven, comprising the steps of forming a web of loose fibers, applying one or more antimicrobials to the web of loose fibers to form treated fibers, blending the treated fibers with untreated binder fibers to form blended fibers and converting the blended fibers into nonwovens. The nonwoven blend fabric comprises 40-90 wt. % of at least one treated fiber that are treated with one or more antimicrobial chemicals listed above and 10-60 wt. % of at least one untreated binder fiber. The one or more antimicrobial chemicals used, in some embodiments, are at a concentration of 0.0003-0.1 wt. %. In some embodiments, silver chloride is used as an antimicrobial. In other embodiments, chitosan may be used as an antimicrobial agent. In some embodiments, one or more other natural and safe antimicrobial chemicals (e.g., silver nitrate, copper, copper nitrate, zinc, nano-silver, chitosan, triclosan, quaternary ammonium compounds, polybiguanides, etc.) are used in the nonwoven.

Another aspect of the invention includes recyclability of the nonwoven. Most of the articles discussed herein may be readily recycled and can be reintroduced into commerce following sterilization, decomposition and return to their prior staple fiber state.

Other features and advantages of the present invention will be set forth in the description of invention that follows, and in part will be apparent from the description or may be learned by practice of the invention. The invention will be realized and attained by the compositions and methods particularly pointed out in the written description and claims hereof.

### BRIEF DESCRIPTION OF THE DRAWINGS

FIG. 1 is a flow chart of a manufacturing method of antimicrobial nonwoven fabric.

FIG. 2 is a schematic diagram of an antimicrobial nonwoven face covering. Various uses of the antimicrobial nonwoven face covering are indicated by arrows.

FIG. 3 is a schematic diagram of an antimicrobial nonwoven air filter. Various uses of the antimicrobial nonwoven air filter are indicated by arrows.

FIG. 4 is a schematic diagram of antimicrobial nonwoven bedding surface coverings and bedding materials. Various uses of the antimicrobial nonwoven bedding surface coverings and bedding materials are indicated by arrows.

FIG. 5 is a schematic diagram of an antimicrobial nonwoven pillow/cushion. Various uses of the antimicrobial nonwoven pillow/cushion are indicated by arrows.

### DETAILED DESCRIPTION

The present invention provides antimicrobial nonwovens and methods of fabricating such nonwovens, most particularly, a method for exhausting, impregnating or molecularly grafting antimicrobial chemicals into fibers and nonwovens. Methods of using the antimicrobial nonwovens as protective articles against bacterial and/or viral infection(s) are also disclosed herein. The antimicrobial nonwovens are manufactured from cellulosic and/or synthetic fibers that are partially or entirely treated with one or more antimicrobial chemicals. In some preferred embodiments, the invention is an antimicrobial nonwoven which comprises at least one antimicrobial chemical treated fiber and at least one untreated binder fiber. In some embodiments, 20-99 wt. %, preferably 30-95 wt. %, more preferably 40-90 wt. % of at least one antimicrobial chemical treated fiber and 5-80 wt. %, preferably 8-70 wt. %, more preferably 10-60 wt. % of at least one untreated binder fiber.

A “nonwoven” described herein, is a manufactured sheet, web, or batt of natural and/or man-made fibers or filaments that are bonded to each other by any of several means. Manufacturing of nonwoven product is well described in “Nonwoven Textile Fabrics” in Kirk-Othmer Encyclopedia of Chemical Technology, 3^{rd} Ed., Vol. 16, July 1984, John Wiley & Sons, p. 72-124 and in “Nonwoven Textiles”, November 1988, Carolina Academic Press. Web bonding methods include mechanical bonding (e.g., needle punching, stitch, and hydro-entanglement), chemical bonding using binder chemicals (e.g., saturation, spraying, screen printing, and foam), and thermal bonding using binder fibers with low-melting points. Two common thermal bonding methods are air heating and calendaring. In some embodiments, hot-air thermal bonding using low-melt binder fibers may be employed to manufacture the nonwoven. In these embodiments, the low-melt binder fibers melt at a lower temperature than the melting point or decomposition temperature of other synthetic or cellulosic fibers (e.g., one or more antimicrobial treated fibers and/or untreated cellulosic fibers) so that the binder fibers serve to hold the one or more antimicrobial treated synthetic or cellulosic fibers and/or the untreated synthetic or cellulosic fibers together in a nonwoven. Preferred melting temperatures of binder fibers and cellulosic fibers are described in U.S. Pat. No. 10,508,370, herein incorporated by reference.

The “fibers” or “fibrous materials” described in the present invention may be any types of synthetic and/or natural fibers. In preferred embodiments, synthetic fibers are used. In these preferred embodiments, the synthetic fibers are polyester. In other embodiments, the fibers may be synthetic and/or cellulosic fibers. Exemplary fibers which can be used in the practice of the invention include but are not limited to: cotton, kapok, flax, ramie, kenaf, abaca, coir, hemp, jute, sisal, rayon, bamboo fiber, Tencel®, and Modal® fibers, glass fibers, basalt fibers, Kevlar® fibers, aramid fibers, polyester fibers (e.g., which can function both as a binder fiber but, depending on the polyester, as part of the nonwoven blend), wool (which may be obtained, for example, from one of the forty or more different breeds of sheep, and which currently exists in about two hundred types of varying grades), silk, rayon (a man-made fiber that may include viscose rayon and cuprammonium rayon), acetate (a man-made fiber), nylon (a man-made fiber), acrylic (a man-made fiber), triacetate (a man-made fiber), spandex (an elastomeric man-made fiber such as Lycra®), polyolefin/polypropylene (man-made olefin fibers), microfibers and microdeniers, lyocell (a man-made fiber), vegetable fiber (a textile fiber of vegetable origin, such as cotton, kapok, jute, ramie, polylactic acid (PLA) or flax), vinyl fiber (a manufactured fiber), alpaca, angora, carbon fiber (suitable for textile use); (t) glass fiber (suitable for textile use), raffia, ramie, vinyon fiber (a manufactured fiber), Vectran® fibers (manufactured fiber spun from Celanese Vectra® liquid crystal polymer), and waste fiber. Fibers are commercially available from sources known by those of skill in the art, for example, E.I. Du Pont de Nemours & Company, Inc. (Wilmington, Del.), American Viscose Company (Markus Hook, Pa.), Teijin Frontier Co., Ltd. (Osaka, Japan), Tintoria Piana USA (Cartersville, Ga.), and Celanese Corporation (Charlotte, N.C.).

In addition to the fibers described herein, other fibers (i.e., optional fibers) may be included in manufacturing the antimicrobial nonwovens to achieve properties or characteristics of interest (e.g., color, texture, etc.). The optional fibers may be present in sufficient amounts to provide a characteristic to the antimicrobial fibers such as softness, texture, appearance, resilience, and cost benefit. In some applications, the antimicrobial fibers may also include fabrics knitted or woven from different cellulosic fibers as described herein. In other embodiments, multiple layers of additional fibers maybe added or attached to antimicrobial nonwovens. Other layers of fibers may include alginate, viscose, carboxymethyl chitosan, acylated chitosan, carboxymethyl cellulose, carboxylethyl cellulose, water insoluble cellulose alkyl sulfonate, bi-component, polyvinyl alcohol, polypropylene, polyethylene terephthalate, polyacrylonitrile, cross-linked acrylate copolymer, wood pulp and combinations thereof.

As used herein, the term “antimicrobial”, “antimicrobial agent” or “antimicrobial chemicals” refers to a composition that has the effect of irradicating or suppressing the growth of bacteria, viruses, fungi, yeast, algae and parasites. The total amount of antimicrobial in fibrous materials is about 0.00015-0.2 wt. %, preferably 0.0002-0.15 wt. %, more preferably 0.0003-0.1 wt. % (% by total weight of fiber, fabric, or nonwoven). In some embodiments, the antimicrobial material may be at a higher concentration, for example, 0.001-20 wt. %, preferably 0.002-15 wt. %, more preferably 0.003-10 wt. % of total fibrous material. In other embodiments, the antimicrobial material may be in the fibrous material at a lower concentration, for example, 0.00005-0.01 wt. %, preferably 0.00015-0.006 wt. %, more preferably 0.0003-0.06 wt. % of total fibrous material. In some embodiments, one or more other natural and/or safe antimicrobial and antiviral chemicals may be used such as silver nitrate, copper, copper nitrate, zinc, nano-silver, chitosan, triclosan, quaternary ammonium compounds and poly biguanides. In preferred embodiments, silver chloride is used as an antimicrobial. In these embodiments, a plurality of silver containing compounds or silver complexes may be used as antimicrobial chemicals. The term “silver containing chemicals” encompasses elemental silver including silver nanoparticles. The term also includes compounds that are either silver ion-exchange resins, zeolites, or substituted glass compounds that release the particular metal ion bonded thereto upon the presence of other anionic species. Some other exemplary silver containing chemicals include silver nitrate, silver fluoride, silver bromide, silver oxide, silver sulfate, silver cyanide, silver tetrafluoroborate, silver sulfide, silver acetate, silver lactate, silver benzoate, silver cyclohexanebutyrate, silver diethyldithiocarbamate, silver trifluoromethanesulfonate, silver carbonate, silver sodium zirconium hydrogen phosphate and mixtures thereof. It is well known in the art that, unlike most chloride salts, silver chloride is unusually insoluble in water. Other additive chemical components of the impregnated material may be included, such as one or more anionic, cationic, nonionic component, preservative, emulsifier, antioxidants, pigments, adhesive, lubricant, antifoam agents, an oil, an organic solvent, and an alcohol, in which the components may be present individually or in combination. The amount of total combined additive non-antimicrobial chemical components may preferably be in an amount totaling 0.0001-10 wt. %, preferably 0.0001-8 wt. %, more preferably 0.0001-5 wt. % of the fibrous material. Also well known in the art is the conversion of silver chloride to silver (and chlorine) upon illumination or heating. To prevent undesired side effects of the chemical, the lowest possible concentration for sufficient antimicrobial activities (i.e., 0.0003-0.1 or lower in wt. %) of silver chloride or any other silver containing chemicals may be used.

In some embodiments, additional antibiotic agents may be used in combination with the antimicrobial agents listed above. Exemplary antibiotic agents may be selected from the group consisting of gentamicin sulfate, penicillin, cephalothin, ampicillin, amoxicillin, augmentin, aztreonam, imipenem, streptomycin, gentamicin, vancomycin, clindamycin, erythromycin, azithromycin, polymyxin, bacitracin, amphotericin, nystatin, rifampicin, tetracycline, doxycycline, chloramphenicol, nalidixic acid, ciprofloxacin, sulfanilamide, gantrisin, trimethoprim, isoniazid, para-aminosalicylic acid, and minocycline.

In another embodiment, the nonwovens may include additional anti-infection agents. In these embodiments, any antimicrobial agent, such as an antibacterial agent, an antiseptic agent, etc., may be used to prevent infection. Non-limiting examples of antiseptics include hexachlorophene, cationic biguanides (i.e., chlorhexidine, cyclohexidine) iodine and iodophores (i.e., povidone-iodine), para-chloro-meta-xylenol, triclosan, furan medical preparations (i.e., nitrofurantoin, nitrofurazone), methenamine, aldehydes (glutaraldehyde, formaldehyde), silver sulfadiazine and alcohols. Nonlimiting examples of classes of antibiotics that may be used include tetracyclines (e.g., minocycline), rifamycins (e.g., rifampin), macrolides (e.g., erythromycin), penicillins (e.g., nafcillin), cephalosporins (e.g., cefazolin), other beta-lactam antibiotics (e.g., imipenem, aztreonam), aminoglycosides (e.g., gentamicin), chloramphenicol, sufonamides (e.g., sulfamethoxazole), glycopeptides (e.g., vancomycin), quinolones (e.g., ciprofloxacin), fusidic acid, trimethoprim, metronidazole, clindamycin, mupirocin, polyenes (e.g., amphotericin B), azoles (e.g., fluconazole) and beta-lactam inhibitors (e.g., sulbactam). Nonlimiting examples of specific antibiotics that may be used include those listed above, as well as minocycline, rifampin, erythromycin, nafcillin, cefazolin, imipenem, aztreonam, gentamicin, sulfamethoxazole, vancomycin, ciprofloxacin, trimethoprim, metronidazole, clindamycin, teicoplanin, mupirocin, azithromycin, clarithromycin, ofloxacin, lomefloxacin, norfloxacin, nalidixic acid, sparfloxacin, pefloxacin, amifloxacin, enoxacin, fleroxacin, temafloxacin, tosufloxacin, clinafloxacin, sulbactam, clavulanic acid, amphotericin B, fluconazole, itraconazole, ketoconazole, and nystatin.

Another aspect of the present invention is a method for the application of antimicrobial chemical (e.g., silver chloride) to fibers. In some embodiments, a method comprises multiple steps of: applying one or more antimicrobials to fibers to form treated fibers; blending the treated fibers with untreated binder fibers to form a web of blended fibers; and converting the web of blended fibers into nonwovens. As previously described, the nonwovens may be made of 40-90 wt. % of the treated fibers and 10-60 wt. % of the untreated binder fibers. The one or more antimicrobial chemicals are applied to be in the fibers at a final concentration of 0.0003-0.1 wt. % and the one or more antimicrobial chemicals may include silver chloride. In addition, the nonwovens or fabrics may further be woven or knitted to manufacture a multi-layered of fibrous materials. The antimicrobial nonwoven fabric conversion from the blended antimicrobial fibers may be by utilizing the nonwoven process and equipment in U.S. Pat. No. 10,358,745, herein incorporated by reference. The order of the processing steps can be varied considerably, additional processing steps can be included and some of the processing steps can be eliminated.

In preferred embodiments, an antimicrobial chemical (e.g. HeiQ Viroblock NPJ03) is applied using a stock dyeing machine. Fibers are loaded in perforated baskets and placed in the dyeing machine. The antimicrobial chemical is added to the machine and exhausted into the fibers by repeated circulation of the aquouse chemical solution. After the treatment is completed, the treated fiber is hydro-extracted and dried. The antimicrobial treated fiber is commercially available from Tintoria Piana US, Inc (Cartersville, Ga.). The one or more antimicrobial chemicals are applied to the fibers at a concentration of 0.0003-0.1 wt. % and the one or more antimicrobial chemicals may include silver chloride. In addition, the one or more antimicrobial chemicals may be at any concentration between the range of 0.0003-0.1 wt. %; for example, the chemicals may be at a concentration of 0.00035-0.06 wt. %, 0.0004-0.001 wt. %, or 0.0005-0.006 wt. %, etc.

Alternatively, A web of fibers can be proceeded to a chemical treatment, where the fibers pass through spray equipment and/or impregnating chemical bath containing the chemical formulation (i.e., one or more antimicrobial agents) to completely soak the fibers. In some embodiments, chemical formulations collected during the process are sent back to the treatment bath and reused. (e.g., recycled for the purpose of protecting the environment, reducing costs, etc.). In some embodiments, the added antimicrobial agent is a silver containing agent (e.g., HeiQ Viroblock NPJ03, HEIQ Switzerland). In preferred embodiments, the one or more antimicrobial agent may be silver chloride.

In another alternative embodiment, the silver chloride treated web of fibers may be passed through squeeze rollers to remove excess amounts of antimicrobial agents to assure that the fibers contain a targeted concentration of antimicrobials. The detailed method of extracting antimicrobial chemicals in excess is described in U.S. Pat. No. 10,358,745, herein incorporated by reference. For silver chloride, 0.0003-0.1 wt. % of total fibers is a desired target amount in a preferred nonwoven. Following the treatment steps, the chemical treated web of fiber may be directly put into a dryer. In addition, the chemical application step includes, but is not limited to, spraying/pouring chemicals on fibers, dipping or immersing fibers into the bath.

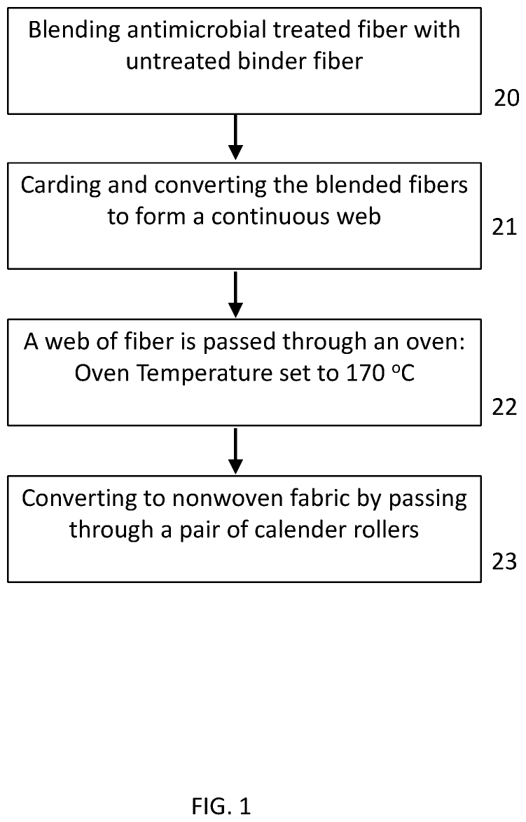

With reference to FIG. 1, a manufacturing method of antimicrobial nonwoven fabric is presented. In preferred embodiments, an antimicrobial nonwoven fabric manufacturing process comprises steps of: i) blending at least one antimicrobial (e.g., Viroblock NPJ03) treated polyester fiber and at least one binder fiber (PET core/PE sheath) 20; ii) carding the blended fibers to a continuous web 21; iii) passing the web through an oven at around 170° C. 22; iv) passing the web through a pair of calender rollers to convert the web to the nonwoven fabric 23; and v) exiting the fabric out of the oven. As described previously, in some embodiments, 40-90 wt. %, 50-90 wt. % or 60-90 wt. % of antimicrobial treated fiber may be blended with 10-60 wt. %, 10-50 wt. % or 10-40 wt. % of binder fiber in the nonwoven manufacturing process.

The size, shape and arrangement of the material of nonwovens may vary widely as long as nonwovens are made directly from separate fibers, molten plastic or plastic films, but not made by weaving or knitting. In some embodiments, the antimicrobial treated fibers are blended with binder fibers. The binder fibers may be polyester-based sheath (e.g., polypropylene and/or polyethylene), which may be recycled after use. Other suitable substrates for binder materials include blends of one or more polyurethane, acrylic, polyethylene terephthalate, polytriphenylene terephthalate, polybutylene terephthalate, polylactic acid, polyamide (e.g., nylon 6, nylon 6,6 and combinations thereof), Polyaramid includes, for example, poly-p phenyleneteraphthalamid (i.e., Kevlar®), poly-m-phenyleneteraphthalamid (i.e., Nomex®) and combinations thereof. Blending with the binder fibers allow the treated natural fibers to be softer, more resilient, lightweight and thermally and acoustically stable. In an exemplary embodiment, the nonwoven is manufactured by hot-air thermal bonding using low-melt and/or elastomeric binder fibers. In some applications, the binding fibers might have a core-sheath configuration where the sheath melts on application of heat and functions to hold the other fibers of the nonwoven together. A plurality of nonwoven formation processes, in addition to melt-blowing, spun-bonding, air-laying, conforming, hydroentangling, and bonded carded web processes, may be used.

In an exemplary embodiment, upon blending of the treated and untreated fibers 20, the blended fibers are carded and converted to form a continuous web 21. The continuous web is then processed through an oven, in which the oven temperature is set at 170° C. 22, and subsequently pass through a pair of calendar rollers for fabrication of the antimicrobial nonwoven fabric 23. In some embodiments, the nonwovens may be recyclable and recycled after use. In other embodiments, 10-100% of the nonwovens or the fibrous materials are from recycled fabrics and the percentage of recycled fabrics varies based upon the strength of material needed for the intended applications and desired characteristics of the products.

The following descriptions and examples illustrate some exemplary embodiments of the disclosed invention in detail. Those of the skill in the art will recognize that there are numerous variations and modifications of this invention that are encompassed by its scope. Accordingly, the description of a certain exemplary embodiment should not be deemed to limit the scope of the present invention

### Example 1

### Antimicrobial Nonwoven Face Covering

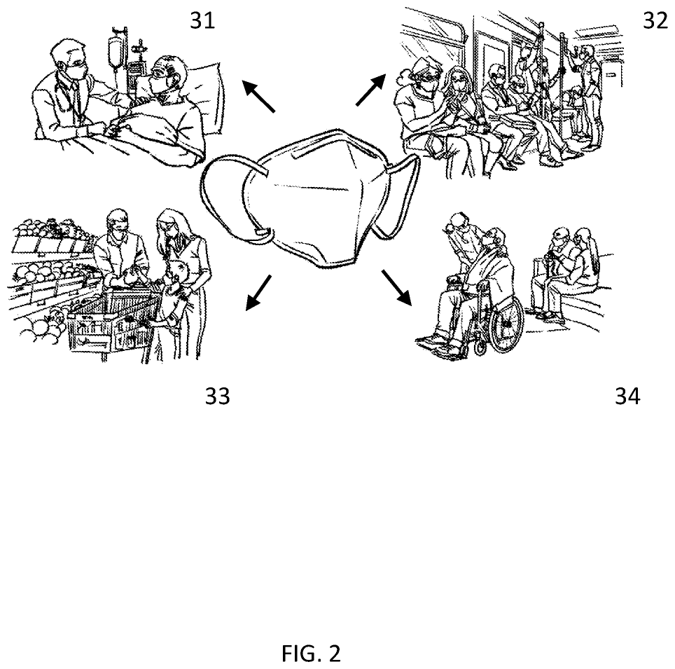

With reference to FIG. 2, a manufactured antimicrobial nonwoven face covering is presented. The face covering is designed to be worn on a wearer's face, covering either some portions or entirely of the face, and includes at least a mask body and a pair of ear straps. The mask may be of disposable type designed for a single, a limited-multiple use or reusable type which can be reused by washing. The mask body covers at least the mouth and nose of a wearer. In preferred embodiments, the mask body includes 20-100%, preferably 30-100%, more preferably 40-100% of antimicrobial nonwovens as described above. Both mask body and ear straps may be fabricated following the antimicrobial fiber manufacturing method described above.

In some embodiments, the antimicrobial nonwoven included in the facial covering comprises a blend of fabrics of 40-90 wt. % of at least one treated fiber that is treated with one or more antimicrobial chemicals listed above and 10-60 wt. % of at least one untreated binder fiber. The one or more antimicrobial chemicals in the facial covering, in some embodiments, are at a concentration of 0.0003-0.1 wt. %. In some embodiments, silver chloride is used as an antimicrobial. In other embodiments, chitosan may be used as an antimicrobial agent. In some embodiments, one or more other natural and safe antimicrobial chemicals (e.g., silver nitrate, copper, copper nitrate, zinc, nano-silver, chitosan, triclosan, quaternary ammonium compounds, polybiguanides, etc.) are used in the nonwoven.

Further, multiple layers of nonwovens may be used to fabricate the face covering. For example, a first fiber sheet and a second fiber sheet which are formed of hydrophobic fibers and hydrophilic fibers, respectively, may be bonded, attached, woven, laid on top of each other to form a face covering. Further, a third fiber sheet having a low density to increase air permeability for ease of breathing of the wearer may be included.

As shown in FIG. 2, the antimicrobial nonwoven face covering may be useful in various environments; some exemplary settings include a clinical hospital 31, a public transportation 32, a shopping center 33 and a senior care center 34.

### Example 2

### Antimicrobial Nonwoven Air Filter

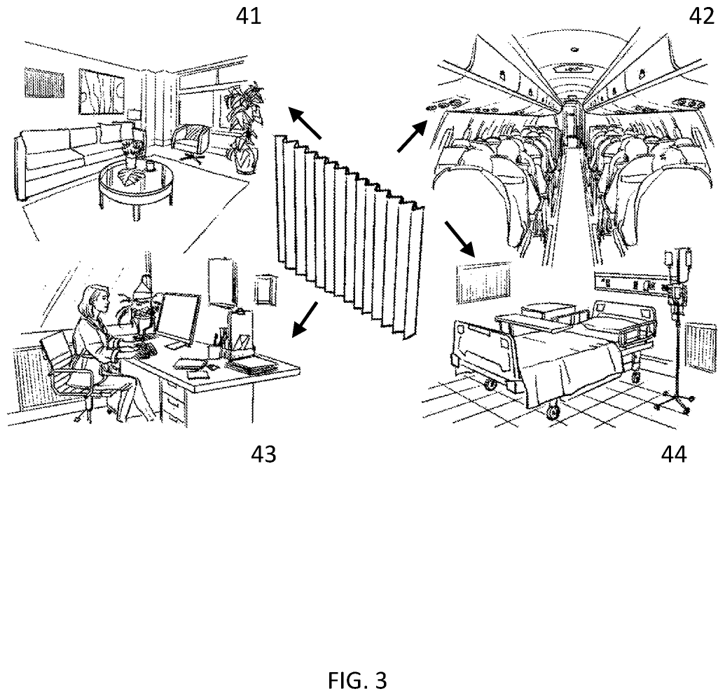

With reference to FIG. 3, an exemplary antimicrobial nonwoven air filter is presented. The nonwoven air filter of the present invention may comprise a plurality of nonwovens or fiber layers to exhibit favorable dust collection capability. In preferred embodiments, the air filter includes 20-100%, preferably 30-100%, more preferably 40-100% of antimicrobial nonwovens as described above. At the same time, in some embodiments, one or more antimicrobial chemicals may be included at a concentration of 0.0003-0.1 wt. %. The one or more antimicrobial chemicals are incorporated into nonwoven fabrics and/or the fibers that make up the nonwovens by exhausting, coating, impregnating and/or layering methods. In some embodiments, silver chloride is used as an antimicrobial. In other embodiments, chitosan may be used as an antimicrobial agent. In some embodiments, one or more other natural and safe antimicrobial chemicals (e.g., silver nitrate, copper, copper nitrate, zinc, nano-silver, chitosan, triclosan, quaternary ammonium compounds, polybiguanides, etc.) are used in the nonwoven.

The nonwoven air filters may be in varying types and form factors. In some embodiments, the nonwoven air filters may be used in combination with commonly used High-efficiency particulate air (HEPA) filters providing air filtering capacity of 99.97% of particles that are 0.3 micron in diameter. Additionally, binder resins may be applied to the nonwoven air filter for enhancing air pollutant collection within the air filter. All known techniques in the art such as impregnation, spraying and application may be used to apply such binder resins. Examples of binder resins include, but are not limited to, water-soluble phenol resin and epoxy resin, polyacrylic acid ester resin emulsions, polyacryl-styrene resin emulsions, and polyvinyl acetate resin emulsions. In particular, polyacrylic acid ester resin emulsions and poly acryl-styrene resin emulsions can be Suitably used since they can adjust the texture of the air filter material easily. The amount of total combined additive non-antimicrobial chemical components (i.e., binder resins) may preferably be in an amount totaling 0.0001-10 wt. %, preferably 0.0001-8 wt. %, more preferably 0.0001-5 wt. % of the fibrous material.

As shown in FIG. 3, the antimicrobial nonwoven air filter may be useful in various environments; some exemplary settings include a confined area such as a personal living area 41, inside an airplane 42, an office 43 and a clinic 44.

### Example 3

### Bedding Surface Covering and Bedding Material

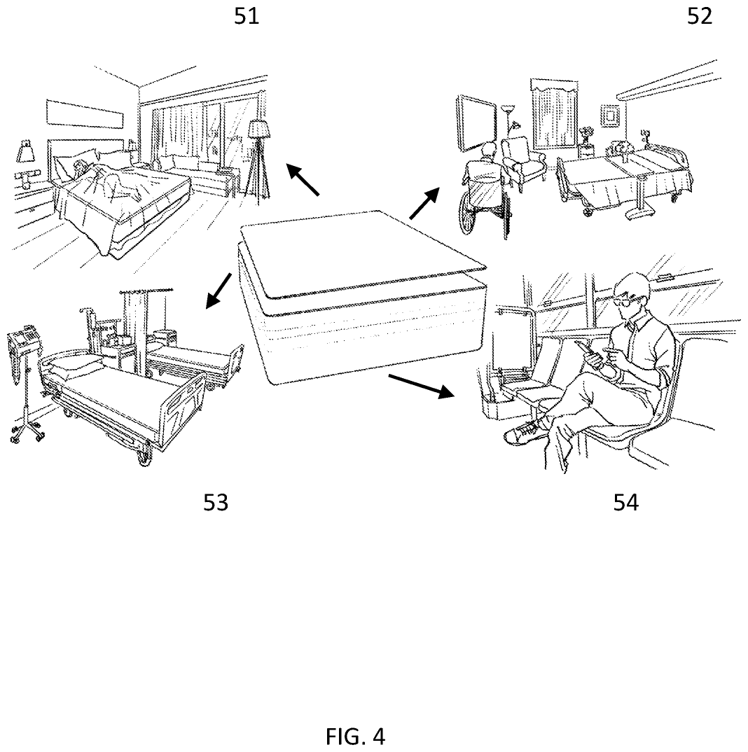

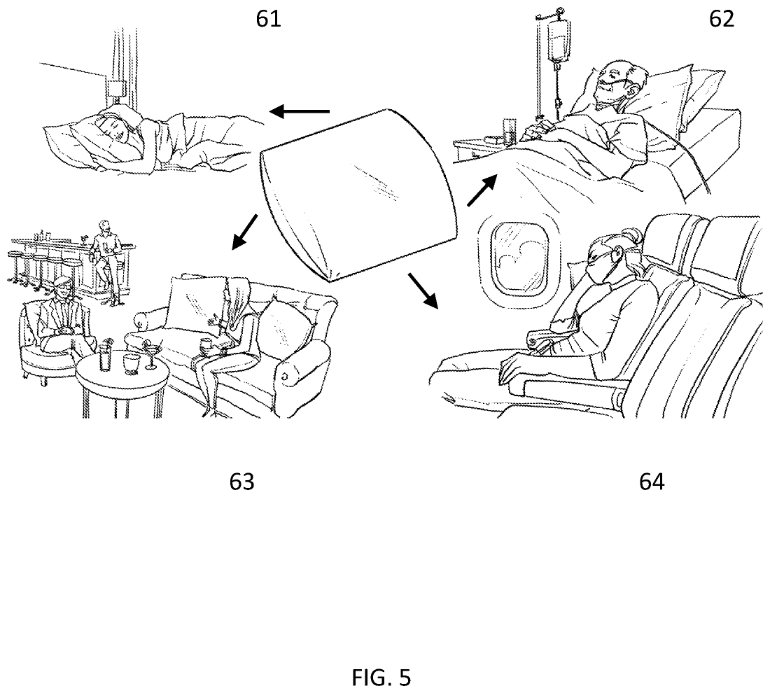

With reference to FIG. 4-5, exemplary antimicrobial bedding surface coverings and bedding materials are presented. The nonwoven bedding surface coverings and bedding materials of the present invention may comprise a plurality of nonwovens or fiber layers. At the same time, in some embodiments, one or more antimicrobial chemicals may be included at a concentration of 0.0003-0.1 wt. %. The one or more antimicrobial chemicals are incorporated into nonwoven fabrics and/or the fibers that make up the nonwovens by coating, impregnating, exhausting and/or layering methods. In some embodiments, silver chloride is used as an antimicrobial. In other embodiments, chitosan may be used as an antimicrobial agent. In some embodiments, one or more other natural and safe antimicrobial chemicals (e.g., silver nitrate, copper, copper nitrate, zinc, nano-silver, chitosan, triclosan, quaternary ammonium compounds, polybiguanides, etc.) are used in the nonwoven.

The antimicrobial nonwovens or fibrous materials that are manufactured into bedding surface coverings and/or bedding materials may be used as mattress encasings, mattress covers 51, mattress toppers 52, mattresses, pillows, pillowcases, duvet cases, bedsheets 53, etc. As used herein, the terms “bedding surface coverings”, “beddings”, “surface coverings”, “bedding applications” and “bedding materials” may be used interchangeably. Such beddings may further include one of the following materials: a knit polyester, a knit polyester with a polyurethane backing, a spunbond/meltblown/spunbond olefin, a woven polyester, a woven cotton-polyester blend, and combinations thereof. Similarly, as it is apparent to one with skill in the art, the antimicrobial nonwovens may be used to fabricate any types of surface covers (e.g., seat covers in public transportation 54, 64, bench covers, desk covers, medical device covers, doorknob covers, etc.). In addition, the antimicrobial nonwovens, alone or in combinations with multiple layers of nonwovens or other woven materials, may be manufactured into antimicrobial pillows 61, 62 and/or cushions 63, as well as antimicrobial pillow/cushion coverings.

Similar to other nonwovens described previously, the antimicrobial nonwoven bedding surface coverings and bedding materials may include at least one antimicrobial treated fiber (e.g., synthetic polyester fiber) which comprises 40-90 wt. % of the nonwoven. The nonwovens may further include at least one untreated binder fiber (e.g., polyester (PET) core/polyethylene (PE) sheath binder fiber) which comprises 10-60 wt. % of the nonwoven. In addition, the nonwoven bedding surface coverings and bedding materials may comprise 10-100% of recycled materials.

### Example 4

Antibacterial activity of nonwoven was determined by using the International Standard (ISO) 20743 method, titled “Textiles—Determination of Antibacterial Activity of Antibacterial Finished Products”. Staphylococcus aureus (ATCC 6538P) was used as an exemplary microorganism for this study.

The test result showed that 99.98% (log reduction 3.6) of bacteria were reduced in the treated polyester fibers. When the nonwoven was fabricated by blending 70% of treated polyester fibers and 30% untreated binder fibers, 99.997% (log reduction 4.5) of bacteria reduction was observed.

### Example 5

Antiviral activity of nonwoven was determined by using the International Standard (ISO) 18184 method, titled “Determination of antiviral activity of textile products”. The test virus used for the study is Influenza A virus (H1N1) (ATCC VR-1469). The ISO 20743 was performed by following the standard protocol as described by International Organization for Standardization (ISO). The result showed 99.999% (log reduction 5.1) of virus reduction in the nonwoven, which was fabricated by blending 70% of treated polyester fibers and 30% untreated binder fibers.

### Example 6

An exemplary antimicrobial fabric product (e.g., face covering, air filter, mattress covers, surface covers, etc.) labeling content is disclosed herein.

TABLE 1
List of active ingredients

| Active Ingredient | % |
|---|---|
| Silver Chloride | 0.00102 |
| Other (Fabric) | 99.99898 |
| Total | 100 |

### Antimicrobial Fabric—Fabricated Product Label

Laboratory testing has shown that this surface:

Continuously reduces bacteria or virus contamination, achieving 99.9% reduction within 2 hours of exposure.

Kills greater than 99.9% of Gram-negative and Gram-positive bacteria* within 2 hours of exposure.

Delivers continuous and ongoing antibacterial* action, remaining effective in killing greater than 99.9% of bacteria* within 2 hours.

Kills greater than 99.9% of bacteria* within two hours and continues to kill 99% of bacteria* even after repeated contaminations.

Helps inhibit the buildup and growth of bacteria* within 2 hours of exposure between routine cleaning and sanitizing steps.

This product is made (out of)(from) a (silver chloride) surface that continuously kills bacteria left behind (by dirty hands) (on the surface) killing more than 99.9% of bacteria within 2 hours.

Continuously inactivates (kills) greater than 99.9% of viruses** within 2 hours.

Delivers continuous and ongoing virucidal** action, remaining effective in inactivating (killing) greater than 99.9% of viruses** within 2 hours.

This product is made (out of)(from) a (silver chloride) surface that continuously inactivates (kills) more than 99.9% of viruses** left behind (by dirty Hands)(on the surface) within 2 hours.

Washing or laundering products manufactured with antimicrobial fabric removes the active ingredient and reduces the effectiveness of the product against bacteria and viruses.

Storage: store in a cool, dry, well-ventilated area away from heat and flame.

Pesticide disposal: discard the outer packaging and this used product in the trash.

Recycling protocol: varies by product, follow procedures approved by state and local authorities.

* Staphylococcus aureus, Enterobacter aerogenes, Methicillin-Resistant Staphylococcus aureus (MRSA), Escherichia coli O157:H7, Pseudomonas aeruginosa and, Vancomycin-Resistant Enterococcus faecalis (VRE).

### ** Influenza A Virus (H1N1) and Severe Acute Respiratory Syndrome Coronavirus 2 (SARS-CoV-2).

### Directions for Use

### Proper Care and Use

Healthcare facilities must maintain the product in accordance with infection control guidelines. The use of this surface is a supplement to and not a substitute for standard infection control practices; users must continue to follow all current infection control practices, including those practices related to cleaning and disinfection of environmental surfaces. This surface has been shown to reduce microbial contamination, but does not necessarily prevent cross contamination. This surface may be subject to recontamination and the level of active bacteria at any time will depend on the frequency and timing of recontamination and cleanliness of the surface (among other factors). In order to have proper antiviral effect, this product must be maintained according to the directions for use. Not approved for direct food contact or food packaging uses.

### Storage and Disposal

Do not contaminate water, food, or feed by storage or disposal.
Storage: Store in a cool, dry, well-ventilated area away from heat and flame.
Pesticide disposal: Wastes from the use of this product may be disposed of at an approved waste disposal.
Container handling: Nonrefillable container. Offer for recycling if available or by other procedures approved by state and local authorities.

It is to be understood that this invention is not limited to any particular embodiment described herein and may vary. It is also to be understood that the terminology used herein is for the purpose of describing particular embodiments only, and is not intended to be limiting, since the scope of the present invention will be limited only by the appended claims.

Where a range of values is provided, it is understood that each intervening value between the upper and lower limit of that range (to a tenth of the unit of the lower limit) is included in the range and encompassed within the invention, unless the context or description clearly dictates otherwise. In addition, smaller ranges between any two values in the range are encompassed, unless the context or description clearly indicates otherwise.

Unless defined otherwise, all technical and scientific terms used herein have the same meaning as commonly understood by one of ordinary skill in the art to which this invention belongs. Representative illustrative methods and materials are herein described; methods and materials similar or equivalent to those described herein can also be used in the practice or testing of the present invention.

All publications and patents cited in this specification are herein incorporated by reference as if each individual publication or patent were specifically and individually indicated to be incorporated by reference, and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual dates of public availability and may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as support for the recitation in the claims of such exclusive terminology as “solely,” “only” and the like in connection with the recitation of claim elements, or use of a “negative” limitations, such as “wherein [a particular feature or element] is absent”, or “except for [a particular feature or element]”, or “wherein [a particular feature or element] is not present (included, etc.) . . . ”.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

We claim:

1. An antimicrobial nonwoven, comprising:
at least one treated fiber, wherein the at least one treated fiber is treated with one or more antimicrobial chemicals; and
at least one untreated binder fiber,
wherein the at least one treated fiber and the at least one untreated binder fiber are blended together as a nonwoven,
wherein the one or more antimicrobial chemicals are at a concentration of 0.0003-0.1 wt. %, and
wherein the one or more antimicrobial chemicals comprise silver chloride.

2. The antimicrobial nonwoven of claim 1, wherein the one or more antimicrobials further comprise at least one compound selected from the group consisting of silver nitrate, copper, copper nitrate, zinc, nano-silver, chitosan, triclosan, quaternary ammonium compounds and poly-biguanides.

3. The antimicrobial nonwoven of claim 1, wherein the at least one treated fiber is a synthetic polyester fiber and comprises 40-90 wt. % of the nonwoven.

4. The antimicrobial nonwoven of claim 1, wherein the at least one untreated binder fiber is a polyester (PET) core/polyethylene (PE) sheath binder fiber and comprises 10-60 wt. % of the nonwoven.

5. The antimicrobial nonwoven of claim 1, wherein the nonwoven is comprised of 10-100% of recycled materials.

6. An antimicrobial face covering, comprising a nonwoven fabric,
wherein said nonwoven fabric is a blend of at least one treated fiber treated with one or more antimicrobial chemicals and at least one untreated binder fiber,
wherein the one or more antimicrobial chemicals are at a concentration of 0.0003-0.1 wt. %, and
wherein the one or more antimicrobial chemicals comprise silver chloride.

7. The antimicrobial face covering of claim 6, wherein the one or more antimicrobials further comprise at least one compound selected from the group consisting of silver nitrate, copper, copper nitrate, zinc, nano-silver, chitosan, triclosan, quaternary ammonium compounds and poly-biguanides.

8. The antimicrobial face covering of claim 6, wherein the at least one treated fiber is a synthetic polyester fiber and comprises 40-90 wt. % of the nonwoven.

9. The antimicrobial face covering of claim 6, wherein the at least one untreated binder fiber is a polyester (PET) core/polyethylene (PE) sheath binder fiber and comprises 10-60 wt. % of the nonwoven.

10. The antimicrobial face covering of claim 6, wherein the nonwoven is comprised of 10-100% of recycled materials.

11. The antimicrobial face covering of claim 6, further comprising a plurality of layers of nonwovens.

12. An air filter, comprising a nonwoven fabric,
wherein said nonwoven fabric is a blend of at least one treated fiber treated with one or more antimicrobial chemicals and at least one untreated binder fiber,
wherein the one or more antimicrobial chemicals are at a concentration of 0.0003-0.1 wt. %, and
wherein the one or more antimicrobial chemicals comprise silver chloride.

13. The air filter of claim 12, wherein the one or more antimicrobials further comprise at least one compound selected from the group consisting of silver nitrate, copper, copper nitrate, zinc, nano-silver, chitosan, triclosan, quaternary ammonium compounds and poly biguanides.

14. The air filter of claim 12, wherein the at least one treated fiber is a synthetic polyester fiber and comprises 40-90 wt. % of the nonwoven.

15. The air filter of claim 12, wherein the at least one untreated binder fiber is a polyester (PET) core/polyethylene (PE) sheath binder fiber and comprises 10-60 wt. % of the nonwoven.

16. The air filter of claim 12, wherein the nonwoven is comprised of 10-100% of recycled materials.

17. A bedding material or bedding surface covering, comprising a nonwoven fabric,
wherein said nonwoven fabric is a blend of at least one treated fiber treated with one or more antimicrobial chemicals and at least one untreated binder fiber,
wherein the one or more antimicrobial chemicals are at a concentration of 0.0003-0.1 wt. %, and
wherein the one or more antimicrobial chemicals comprise silver chloride.

18. The bedding material or bedding surface covering of claim 17, wherein the one or more antimicrobials further comprise at least one compound selected from the group consisting of silver nitrate, copper, copper nitrate, zinc, nano-silver, chitosan, triclosan, quaternary ammonium compounds and poly biguanides.

19. The bedding material or bedding surface covering of claim 17, wherein the at least one treated fiber is a synthetic polyester fiber and comprises 40-90 wt. % of the nonwoven.

20. The bedding material or bedding surface covering of claim 17, wherein the at least one untreated binder fiber is a polyester (PET) core/polyethylene (PE) sheath binder fiber and comprises 10-60 wt. % of the nonwoven.

21. The bedding material or bedding surface covering of claim 17, wherein the nonwoven is comprised of 10-100% of recycled materials.

22. The bedding material or bedding surface covering of claim 17, further comprising a plurality of layers of nonwovens.

23. A method for manufacturing antimicrobial nonwovens, comprising:
applying one or more antimicrobials to fibers to form treated fibers;
blending the treated fibers with untreated binder fibers to form a web of blended fibers; and
converting the web of blended fibers into nonwovens,
wherein the one or more antimicrobial chemicals are applied to the fibers at a concentration of 0.0003-0.1 wt. %, and
wherein the one or more antimicrobial chemicals comprise silver chloride.

24. The method of claim 17, wherein the one or more antimicrobials further comprise at least one compound selected from the group consisting of silver nitrate, copper, copper nitrate, zinc, nano-silver, chitosan, triclosan, quaternary ammonium compounds and poly-biguanides.

25. The method of claim 17, wherein the step of applying one or more antimicrobials to fibers to form treated fibers take place in a perforated container.

26. The method of claim 17, wherein the treated fibers are synthetic polyester fibers and comprise 40-90 wt. % of the nonwovens.

27. The method of claim 17, wherein the untreated binder fibers are polyester (PET) core/polyethylene (PE) sheath binder fibers and comprise 10-60 wt. % of the nonwovens.
